(19) United States
(12) Patent Application Publication
(10) Pub. No.: US 2024/0095386 A1
(43) Pub. Date: Mar. 21, 2024

(54) SYSTEM AND METHOD FOR AGGREGATING VIEWABLE CONTENT FROM MULTIPLE SOURCES VIA USER-FRIENDLY INTERFACE

(71) Applicant: Scott McNeal, Monarch Beach, CA (US)

(72) Inventor: Scott McNeal, Monarch Beach, CA (US)

(21) Appl. No.: 18/306,824

(22) Filed: Apr. 25, 2023

Related U.S. Application Data
(63) Continuation-in-part of application No. 17/932,628, filed on Sep. 15, 2022.
(60) Provisional application No. 63/367,243, filed on Jun. 29, 2022.
(60) Provisional application No. 63/245,679, filed on Sep. 17, 2021.

(51) Int. Cl. G06F 21/62

(52) U.S. Cl. CPC G06F 21/6218

(57) ABSTRACT

System and method allowing users to interface with all available content, including streaming, video on demand, television, websites, podcasts, social media sites, etc., in a seamless, streamlined, easily searchable format thereby eliminating the need for users to move from interface to interface. The content is displayed in easy to search genres, such as comedies, sports, actors, etc. The system and method further provide non-media options (e.g., Food and Shopping) for users to access and interface with while simultaneously watching media content from the media content sources.

### CROSS-REFERENCE

This application claims priority to U.S. Ser. No. 17/932,628 filed Sep. 25, 2022 which claims priority to U.S. Ser. No. 63/245,679 filed Sep. 17, 2021 and U.S. Ser. No. 63/367,243 filed Jun. 29, 2022, all of which are incorporated herein by reference for all purposes.

### FIELD OF THE INVENTION

The embodiments of the present invention relate to an easy-to-use interface populated with multiple forms of media and non-media content, including, for example, streaming, on-demand and cable as well as consumer goods.

### SUMMARY

The advent of cable companies and the set-top-box (STB) used to deliver video content has created a new phenomenon which has been referred to as “channel surfing.” Channel surfing is a term created to describe the user action of traversing, by means of a remote control, a viewable guide of all available programming offered by a cable company and selecting a program therefrom. Once a program is selected, the content is immediately displayed.

In today's world, most users have, in addition to cable and local television providers, one or more streaming services and/or video on demand (VOD) options. A short list of streaming and VOD services include Netflix, Amazon Prime, Hulu, Disney+ and Apple TV. Other content providers may comprise websites, podcasts, influencers, YouTube videos and social media sites such as TikTok, Facebook, Instagram, etc.

While users have more content than ever to select from, one drawback is the challenge of locating the desired content. There is currently no simple method for users search all of their available content simultaneously. Instead, users must use various guides (interfaces) associated with each of the content providers. When unable to locate desired programming via the guide provided by their cable company/local television provider, most users open one of the applications residing on their television. If they are unable to locate desired content via the application, the users typically switch to another application (i.e., a different streaming service) and start the process anew and repeating the process until desired content is located.

It would be advantageous to create a system and method allowing users to interface with all available content, including streaming, video on demand, television, etc., in a seamless, streamlined, easily searchable format thereby eliminating the need for users to move from interface to interface. It would be further advantageous if content is displayed in easy to search genres, such as comedies, sports, actors, etc. It would also be advantageous to provide non-media options (e.g., Food and Shopping) for users to access while watching media content.

Other variations, embodiments and features of the present invention will become evident from the following detailed description, drawings and claims.

### BRIEF DESCRIPTION OF THE DRAWINGS

FIG. 1 illustrates an exemplary cable content guide (interface) searchable by a user desiring to watch cable programming;

FIG. 2 illustrates an exemplary streaming service interface searchable by a user desiring to watch streaming content;

FIG. 3 illustrates a schematic diagram of an exemplary backend of a system according to the embodiments of the present invention;

FIG. 4A illustrates an exemplary default menu according to the embodiments of the present invention according to the embodiments of the present invention;

FIG. 4B illustrates an exemplary user-defined menu according to the embodiments of the present invention according to the embodiments of the present invention;

FIG. 4C illustrates an exemplary secondary sort page according to the embodiments of the present invention according to the embodiments of the present invention;

FIG. 4D illustrates an exemplary user defined content display hierarchy according to the embodiments of the present invention according to the embodiments of the present invention;

FIG. 4E illustrates an exemplary content display hierarchy based on alphabetical order according to the embodiments of the present invention according to the embodiments of the present invention;

FIG. 4F illustrates a selected desired content immediately starting to play according to the embodiments of the present invention;

FIGS. 4G and 4H illustrate the use of an All-Available Content feature according to the embodiments of the present invention according to the embodiments of the present invention;

FIG. 4I illustrates another menu including additional content providers according to the embodiments of the present invention according to the embodiments of the present invention;

FIG. 5A illustrates a flow chart detailing a methodology of generating the interface according to the embodiments of the present invention;

FIG. 5B illustrates a flow chart detailing the methodology of utilizing the interface according to the embodiments of the present invention;

FIG. 6 illustrates exemplary metadata that the system uses to acquire available content from each content provider according to the embodiments of the present invention;

FIGS. 7A and 7B illustrate an alternative interface including non-media content for users to access according to the embodiments of the present invention;

FIGS. 8A-8E illustrate screen shots of a food ordering options with the food preparation entities and food delivery entities associated with the interface according to the embodiments of the present invention;

FIGS. 9A-9B illustrate screen shots of a shopping option associated with the interface according to the embodiments of the present invention;

FIG. 10 illustrates a flow chart detailing use of the alternative embodiment according to the embodiments of the present invention;

FIGS. 11A and 11B illustrate media content and non-media content being displayed simultaneously according to the embodiments of the present invention; and

FIG. 12 illustrates search results including user recommendations related to the search terms according to the embodiments of the present invention; and

FIG. 13 illustrates a leaderboard of users recommending content according to the embodiments of the present invention.

### DETAILED DESCRIPTION

Those skilled in the art will recognize that the embodiments of the present invention involve both hardware and software elements, including AI, which portions are described below in such detail required to construct and operate a system and method according to the embodiments of the present invention.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.), or an embodiment combining software and hardware. Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), and optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied thereon, for example, in baseband or as part of a carrier wave. Such a propagated signal may take any variety of forms, including, but not limited to, electromagnetic, optical, or any suitable combination thereof. A computer readable signal medium may be any computer readable medium that is not a computer readable storage medium and that can communicate, propagate, or transport a program for use by or in conjunction with an instruction execution system, apparatus, or device.

Program code embodied on a computer readable medium may be transmitted using any appropriate medium, including but not limited to wireless, wireline, optical fiber cable, RF and the like, or any suitable combination of the foregoing.

Computer program code for carrying out operations for aspects of the present invention may be written in any combination of one or more programming languages, including an object-oriented programming language such as Java, Smalltalk, C++ or the like or conventional procedural programming languages, such as the “C” programming language, AJAX, PHP, HTML, XHTML, Ruby, CSS or similar programming languages. The programming code may be configured in an application, an operating system, as part of a system firmware, or any suitable combination thereof. The programming code may execute entirely on the user's computer, partly on the user's computer, as a standalone software package, partly on the user's computer and partly on a remote computer or entirely on a remote computer or server as in a client/server relationship sometimes known as cloud computing. In the latter scenario, the remote computer may be connected to the user's computer through any type of network, including a local area network (LAN) or a wide area network (WAN), or the connection may be made to an external computer (for example, through the Internet using an Internet Service Provider) and Wi-Fi.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagrams.

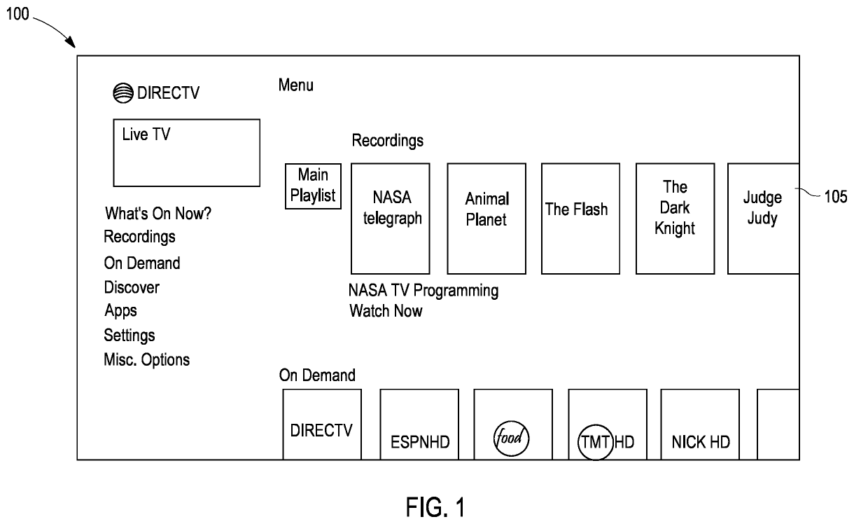

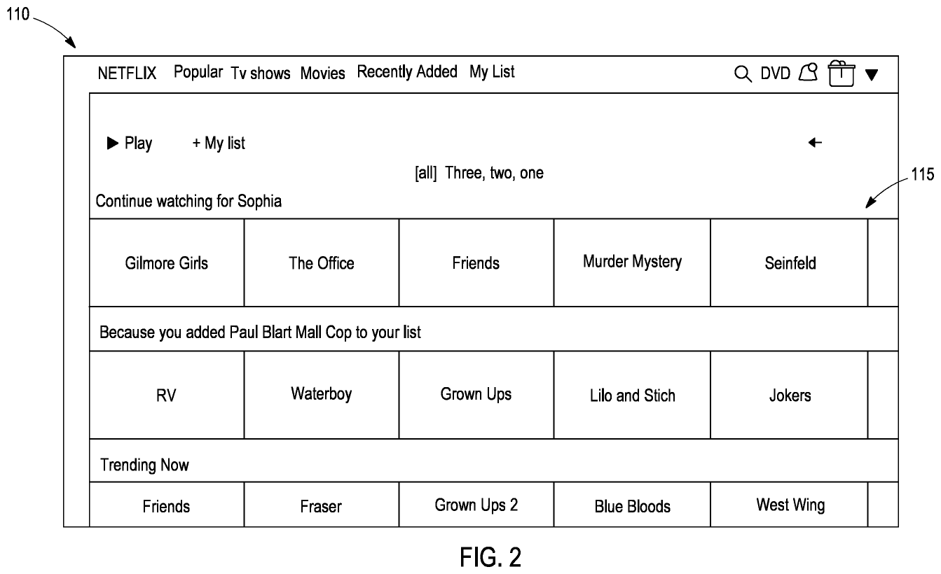

FIGS. 1 and 2 show current guides or interfaces associated with DirecTV (satellite) and Netflix (streaming). Regarding the DirecTV guide 100, a user can scroll up and down through the programming menu 105 using a remote control device. Once a desired show is located, the user can select the show using the remote control device, Similarly, with the Netflix guide 110, a user is able to scroll through categorized streaming content 115 until a desired show is located. Once located, the user may then select the desired show using a remote control device. Both guides interfaces are unique to the specific provider's content. That is, the user cannot search DirecTV programming using the Netflix guide and vice versa. Given the myriad of content providers, locating desired content is inefficient and frustrating since users may need to access and search many guides before finding the desired content.

FIGS. 1 and 2 show individual interfaces 100, 110 for DirecTV and Netflix, respectively. Via the interfaces 100, 110, users may search for content and locate content provided by the respective providers. The current system and method seek to overcome the inefficiency and frustration of using individual interfaces by aggregating all available content, available to the user, in one easy-to-use interface.

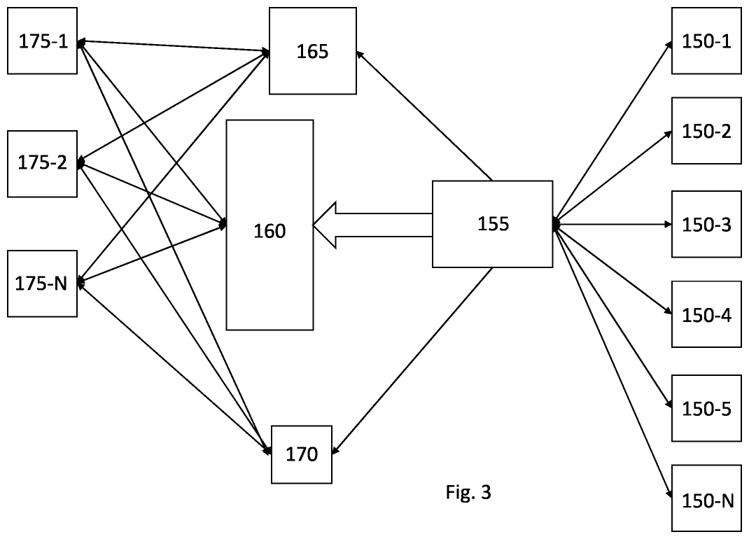

FIG. 3 shows a schematic of an exemplary backend of the system according to the embodiments of the present invention. As shown in FIG. 3, a series of content providers 150-1 through 150-N (e.g., Netflix, Hulu, etc.) communicate with an aggregator 155. The communication may be accomplished via each content provider's application programming interface (“API”) or other means. The aggregator 155 may be a software component or combined hardware and software component. In either embodiment, the aggregator 155 collects and parses relevant data from the content providers and configures the collected and parsed data into a searchable database accessible via a single user interface depicted on a smart TV 160, smart tablet 165 or smart phone 170. When a result is located by the user, the user may click on the content at which point the aggregator 155 communicates with the relevant content provider 150-1 through 150-N causing the desired content to be played on the smart TV 160, smart tablet 165 or smart phone 170. Alternatively, when the user clicks on the desired content, the device communicates directly with the content provider (i.e., bypasses the aggregator) to play the desired content. In one embodiment, the aggregator 155 may be integrated into the smart TV 160, smart tablet 165 or smart phone 170. As detailed below, non-content providers 175-1 through 175-N (e.g., shopping websites, food delivery services, etc.) may communicate simultaneously with the smart TV 160, smart tablet 165 or smart phone 170 via an Internet or Wi-Fi connection.

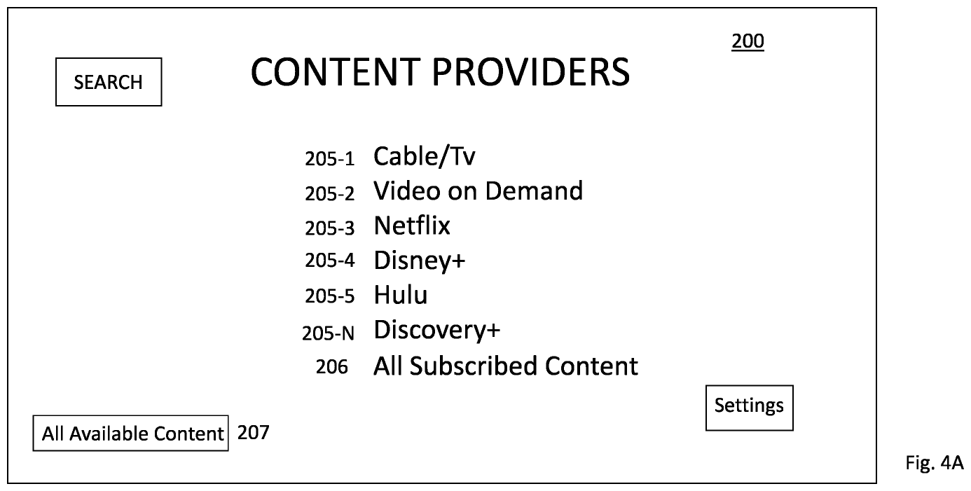

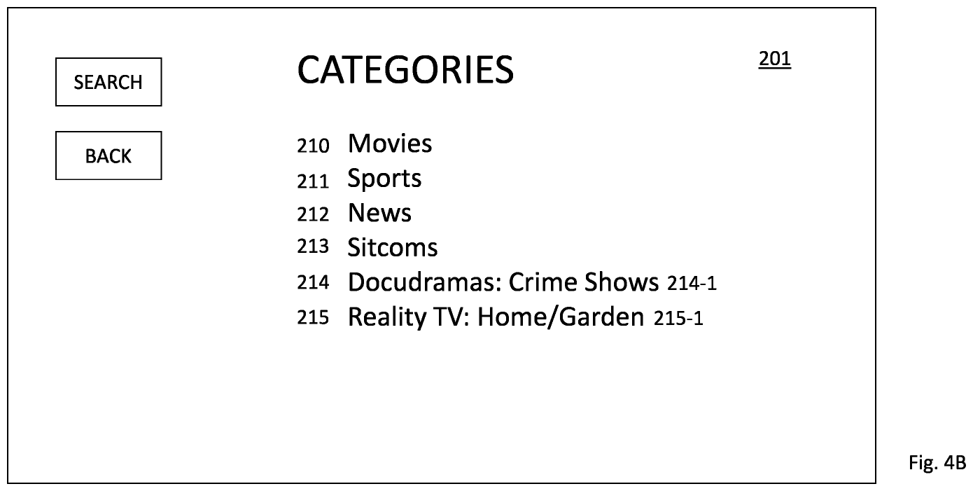

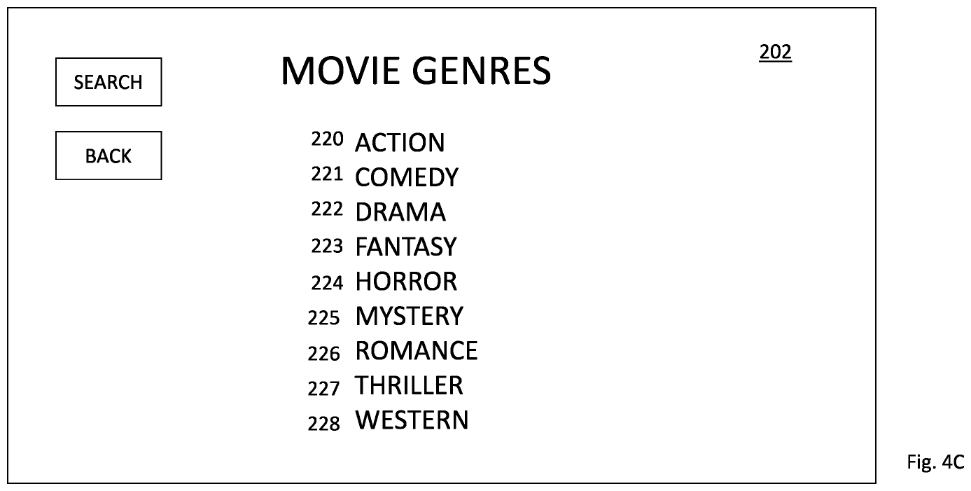

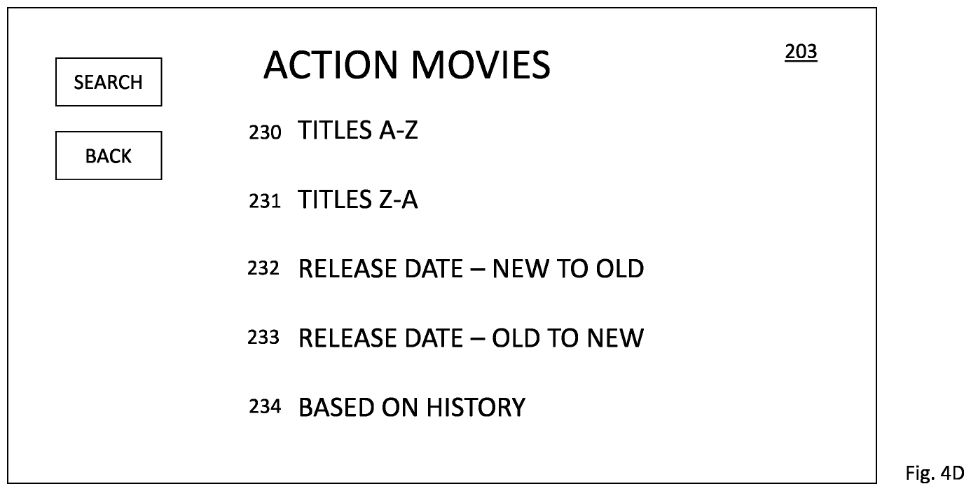

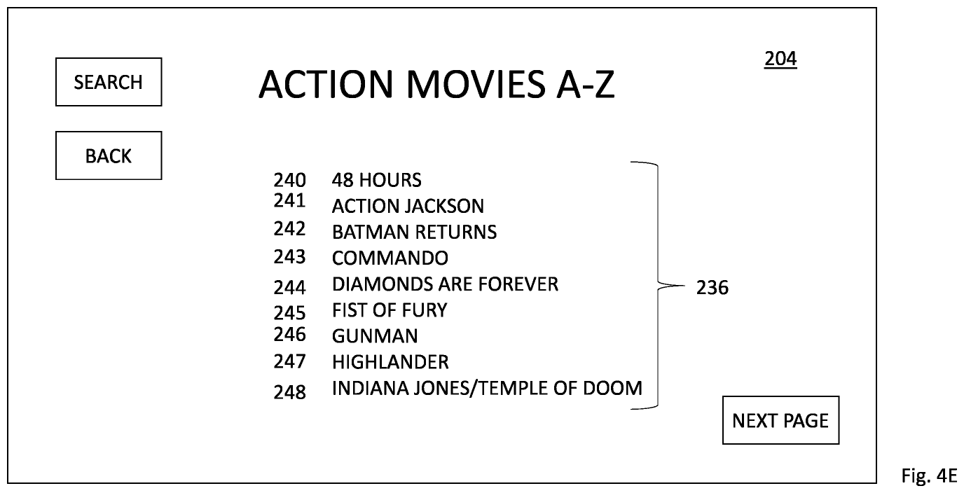

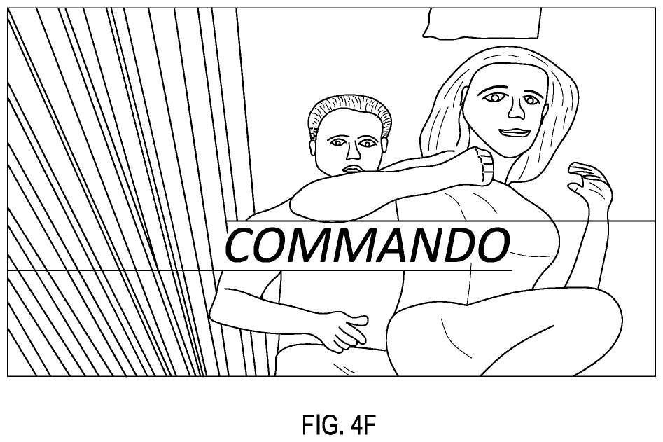

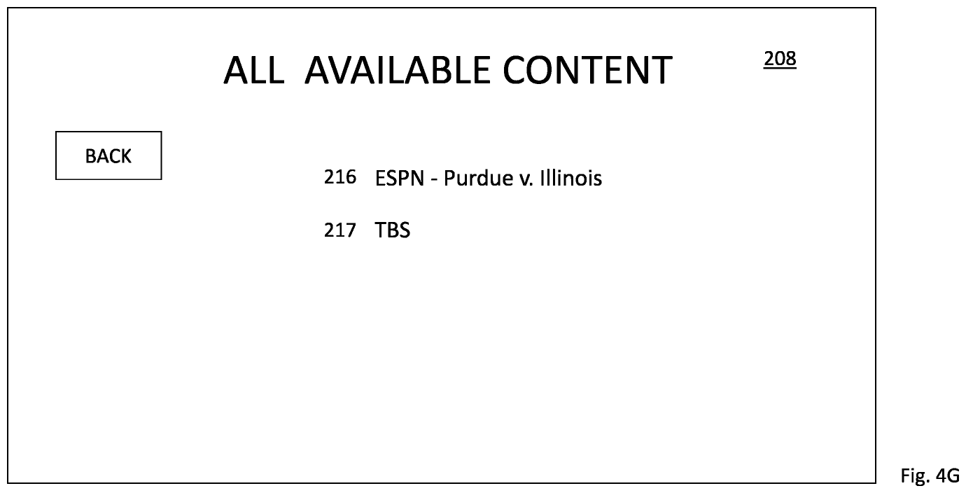

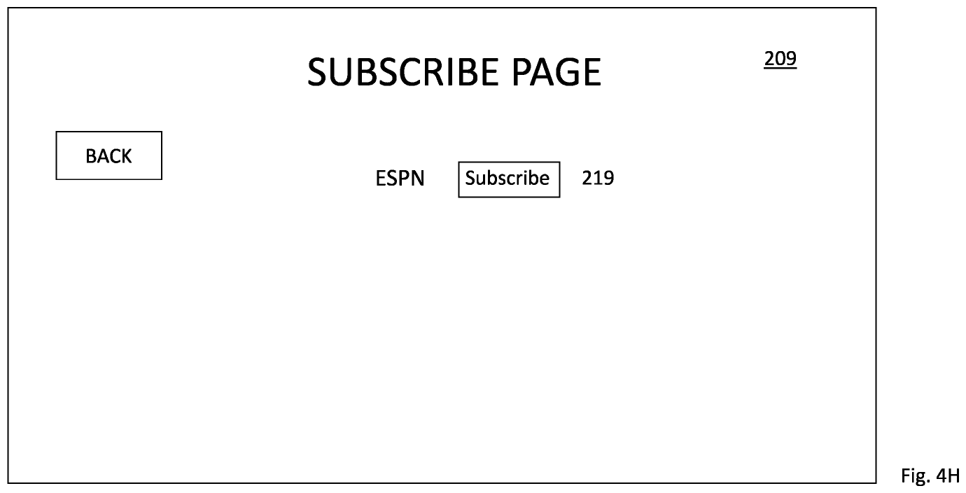

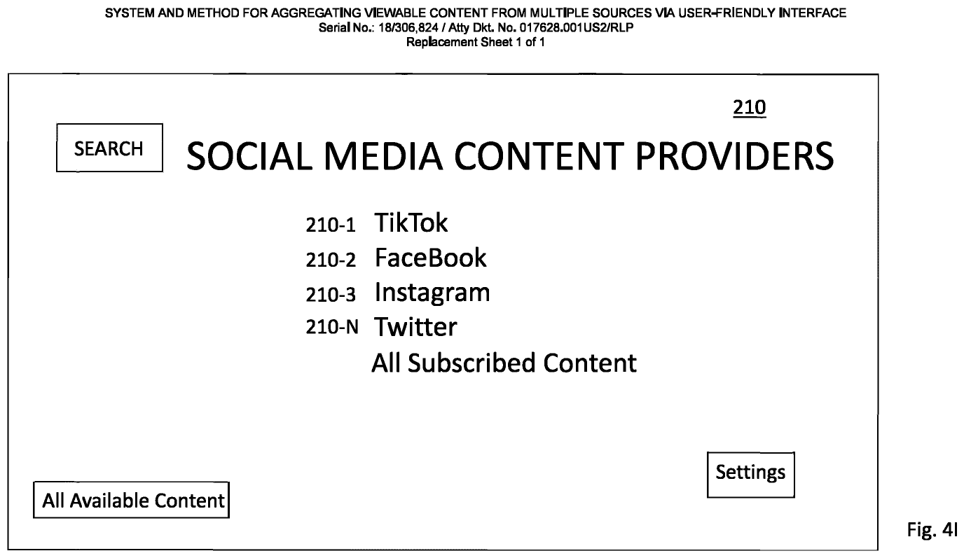

The system detailed herein is configured to reside on a smart device, such as a television, tablet, mobile phone or computer. For purposes of brevity, this detailed description shall focus on the system residing on a smart television (“Smart TV”). A first object of the embodiments of the present invention is to identify those content providers to which the user subscribes or otherwise has access to. FIG. 4A shows an exemplary screen shot 200 detailing a list of content providers 205-1 through 205-N. The list may be populated by the user, or the system may auto-populate based on the system analyzing stored content on the Smart TV. That is, the Smart TV will typically have access to the user's various content-provider accounts as the user's registered details (e.g., username, passwords, etc.) are stored on the Smart TV. There is also an All-Subscribed Content icon 206 that automatically searches all available services to which the user is subscribed. An All-Available Content 207 may search even content providers to which the user does not subscribe and provide an option to subscribe.

Once the list of content providers is finalized, the user may further customize the way located content is catalogued. As shown in screen shot 201 of FIG. 4B, the user has identified categories related to movies 210, sports 211, news 212, sitcoms 213, docudramas 214 (with a subcategory for crime shows 214-1) and reality TV 215 (with a subcategory for home/garden 215-1). Screen shot 202 of FIG. 4C shows a subcategory list comprising action 220, comedy 221, drama 222, fantasy 223, horror 224, mystery 225, romance 226, thriller 227 and western 228, associated with the movie category 210 Those skilled in the art will recognize that other categories and subcategories are available. In one embodiment, the system provides a comprehensive list of available categories and subcategories which the user may select.

The system also provides the user the ability to determine the format with which the located content is displayed. Screen shot 203 of FIG. 4D shows available options comprising alphabetical 230, reverse alphabetical 231, release date from new to old 232, release date for old to new 233 and history 234. Those skilled in the art will recognize that other format options exist.

Screen shot 204 of FIG. 4E shows an abbreviated alphabetical list 236 of action movies from A-Z associated with the action subcategory 220 under the movie category 210. The list comprises 48 Hours 240, Action Jackson 241, Batman Returns 242, Commando 243, Diamonds are Forever 244, Fist of Fury 245, Gunman 246, Highlander 247 and Indiana Jones/Temple of Doom 248.

As shown in FIG. 4E, from the A-Z list 236 depicted responsive to the user selecting the TITLES A-Z 230 option in FIG. 4D, the user can select an action movie to watch. As shown in FIG. 4F, the user has selected Commando. The system in configured to begin the action movie, from its content provider, immediately upon selection from list 236 by the user.

If a desired movie (or other content) does not appear, in one embodiment, the system is configured to show the user which content provider controls rights to the content as shown in FIGS. 4G and 4H. In this manner, the user is prompted to immediately sign up for the new content provider and access the desired content. In one embodiment, the system is part of an affiliate program whereby if a user signs up for the content provider via the system interface, the content provider pays the system operator (e.g., television manufacturer, patent holder, etc.) a portion of the subscriber fees paid thereafter. Alternatively, the system operator retains all the subscriber fees. If the desired movie is available but requires a fee, the system is configured to permit the user to make the payment to the content provider. For example, despite being a subscriber to Prime Video, some of its content (e.g., new releases) requires an additional payment.

Each of the screen shots detailed above include conventional search and back functions and similar well-known functionality by which the user moves about or “surfs” the various pages.

Those skilled in the art will recognize that the system detailed herein may also be used to locate and instantly display other forms of media content including websites, podcasts, influencers, YouTube videos and social media sites such as TikTok, Facebook, Instagram, etc. FIG. 4I shows an exemplary screen shot 210 listing additional types of media content searchable and playable using the system disclosed herein. As shown, media content 210-1 through 210-N may be searched. In the same manner as detailed herein, if a user is already subscribed or a member to the content provider (e.g., YouTube or an influencer's channel), the system stores or otherwise has access to the user's password information so that a user need not spend time accessing a content provider if they are already a member or subscriber allowing content to immediately start playing when located and selected by the user.

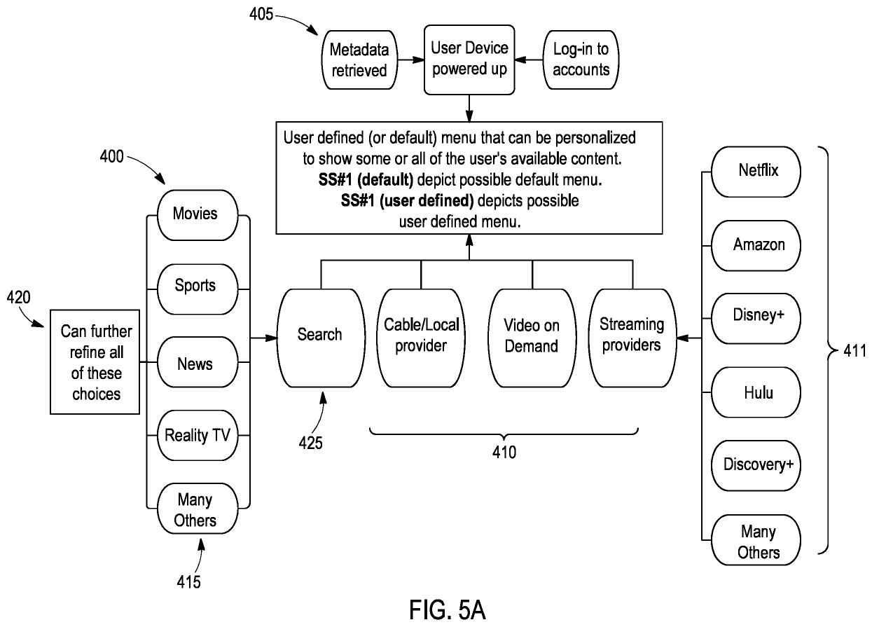

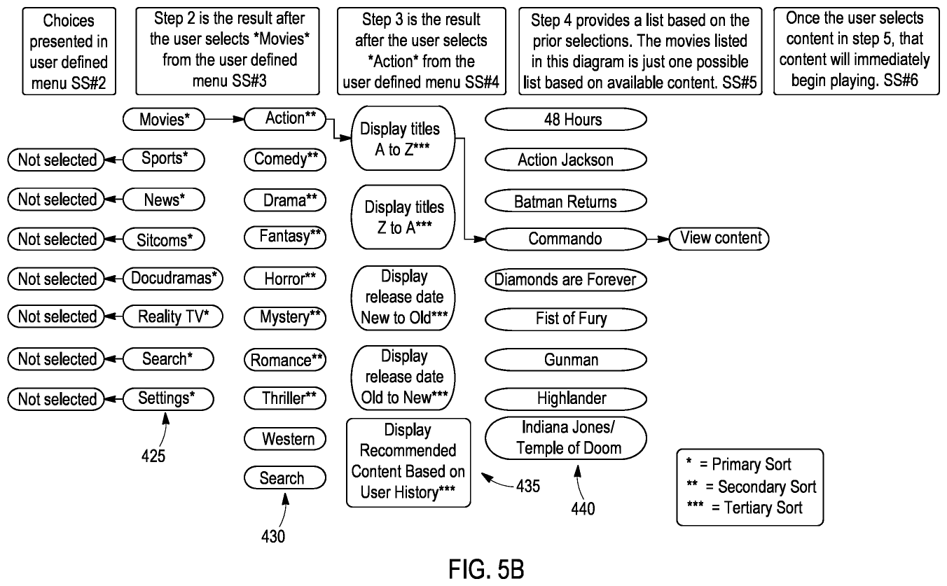

FIGS. 5A and 5B illustrate a flow chart diagram 400 detailing operation of the system and method. In one embodiment, as referenced above, the system resides on a Smart TV. Accordingly, the system may be pre-loaded on the Smart TV when manufactured or may be uploaded/downloaded after the fact by the user or manufacturer using conventional means. In one after-the-fact example, the manufacturer may disseminate the system, as a software application, to its eligible Smart TVs as an update which the user may accept next time the Smart TV is accessed.

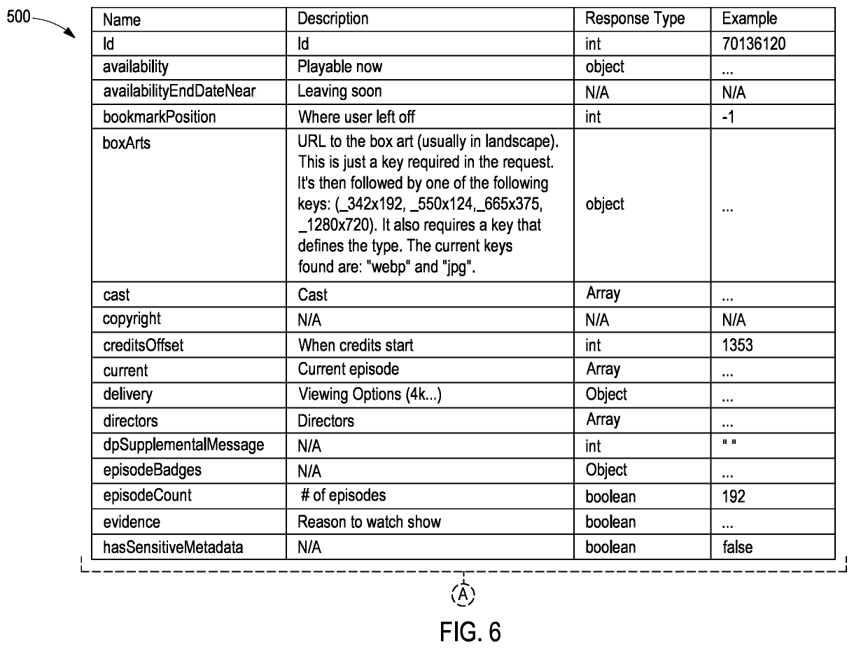

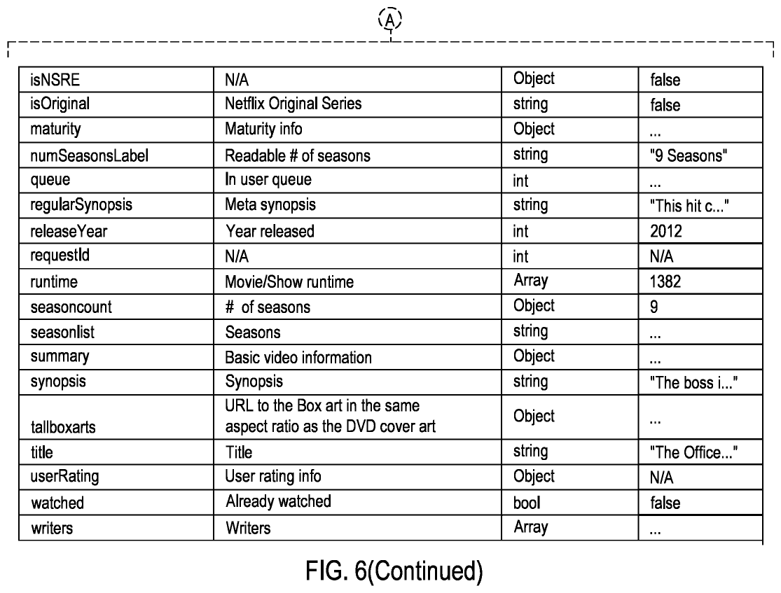

At 405, the system collects and stores content data (i.e., metadata—see table 500 in FIG. 6) from the multitude of content providers using each content provider's application programming interface (“API”). This function may occur each time the Smart TV is powered up to keep an up-to-date list of content or the user may be able to refresh the content when desired. If a content provider does not provide an API, in one embodiment, the system signs into the content provider using the user's account (e.g., username and password) to access the desired metadata. In one embodiment, television cache is utilized to speed up the refreshing of the content.

The user or system creates the list of content providers 410 to which the user subscribes or otherwise has access. As shown, the content providers may be further broken down to show which providers 411 the user subscribes to or may subscribe to. As set forth above, there may also be an All-Available Content search tool whereby users may search content providers to which the user does not currently subscribe. FIG. 4G shows screen shot 208 of the All-Available Content page which displays responsive to the user selecting the All-Available Content icon 207 after learning that the user's subscribed content does not include the desired content. In this instance, the user is looking for a football game between Purdue and Illinois. Screen shot 208 shows that the game is available on ESPN 216 if the user subscribes or TBS 217 which is a free channel with the user's cable package. The user may then select one of the options. If the user selects ESPN, the user is advanced to screen shot 209 of FIG. 4H where the user may subscribe to ESPN via the Subscribe icon 219.

As set forth above, the user (or system) creates content categories 415 and subcategories 420. A search icon 425 allows the user to search the content categories 415 and subcategories 420.

FIG. 5B shows user-defined content categories 425, subcategories 430 and display options 435 including recommended content derived from a user's previous search and viewing habits. Artificial intelligence and/or machine learning may be used to analyze a user's previous search and viewing habits to generate and populate a group of recommended content. A search results list 440 displays the content, as defined by the user, in alphabetical order. When the user selects the desired content (i.e., Commando), the movie begins to play immediately without any further action needed by the user.

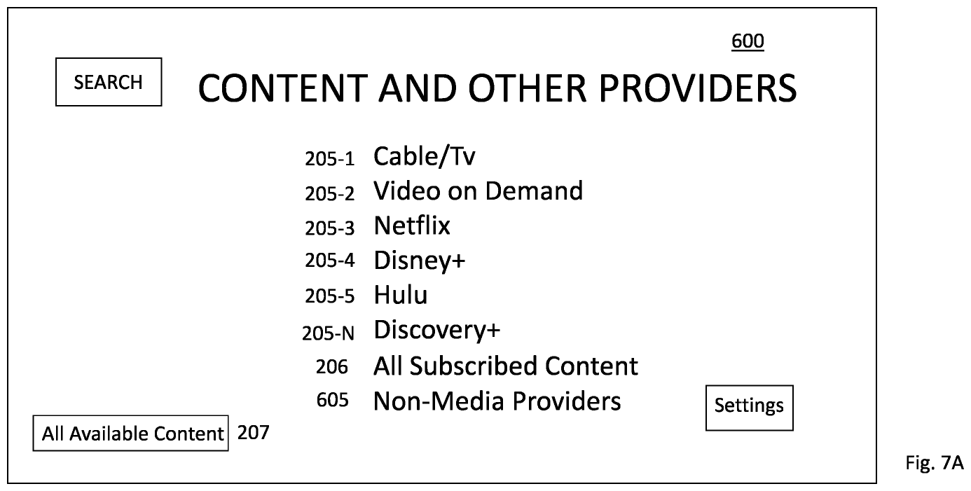

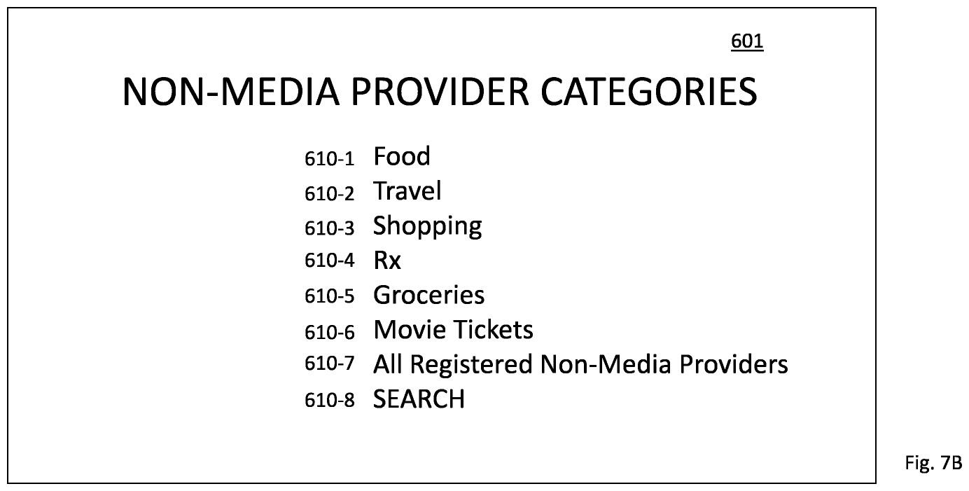

FIGS. 7A and 7B illustrate an alternative interface including non-media providers for users to access according to the embodiments of the present invention. As shown in screen shot 600, the list provides a Non-Media Content category 605. Selecting the Non-Media Content category 605 advances the user to screen shot 601 shown in FIG. 7B. Screen shot 601 lists exemplary Non-Media Categories including Food 610-1, Travel 610-2, Shopping 610-3, Rx 610-4, Groceries 610-5, Movie Tickets 610-6, All Subscribed to Non-Media Providers 610-7 and Search 610-8. Those skilled in the art will recognize that the Non-Media Providers can include any number of categories desired. The list of Non-Media Provider Categories may be pre-populated based on popularity or other factors or customized by the user. The Non-Media Provider Categories may also be pre-populated with those providers with which the user has an account (i.e., is currently a registered user).

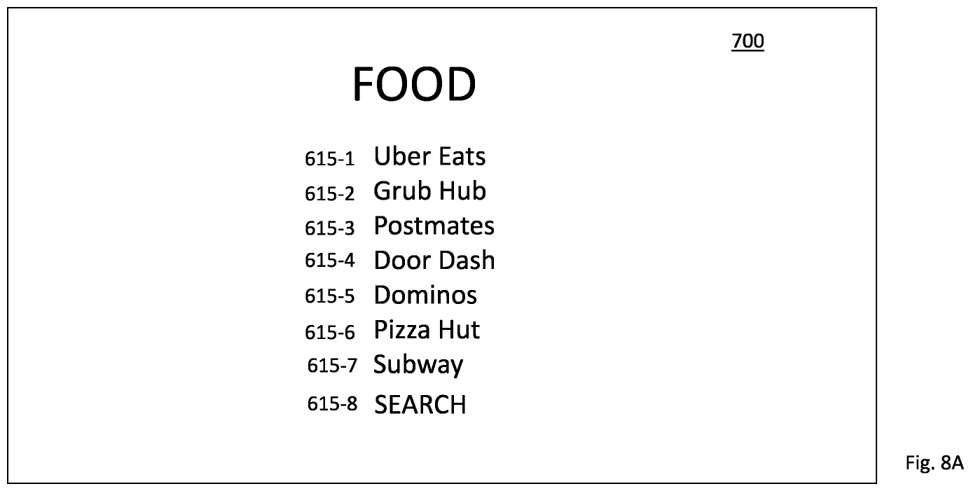

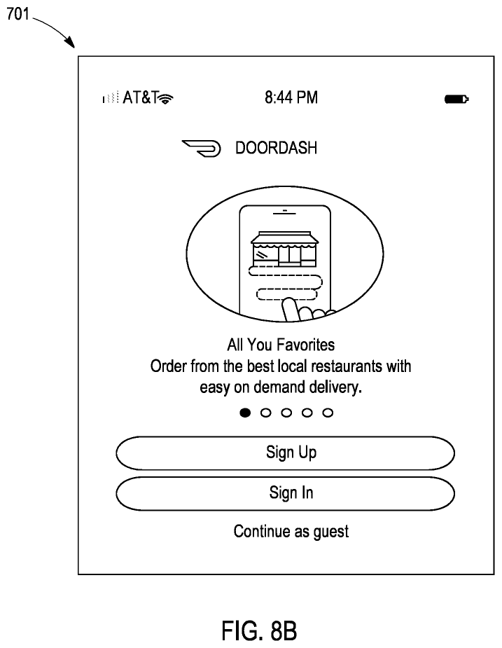

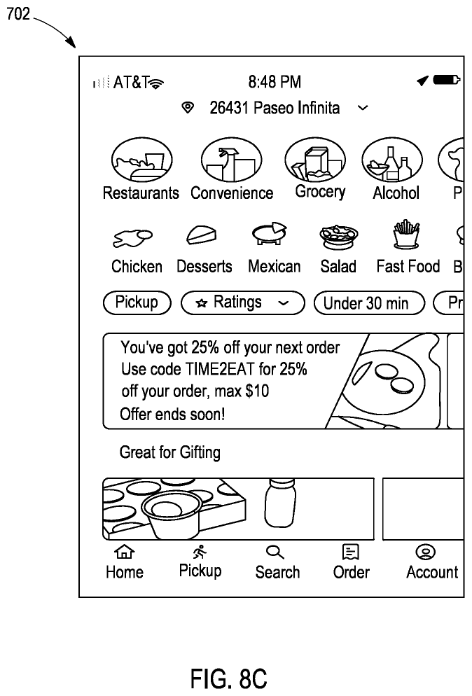

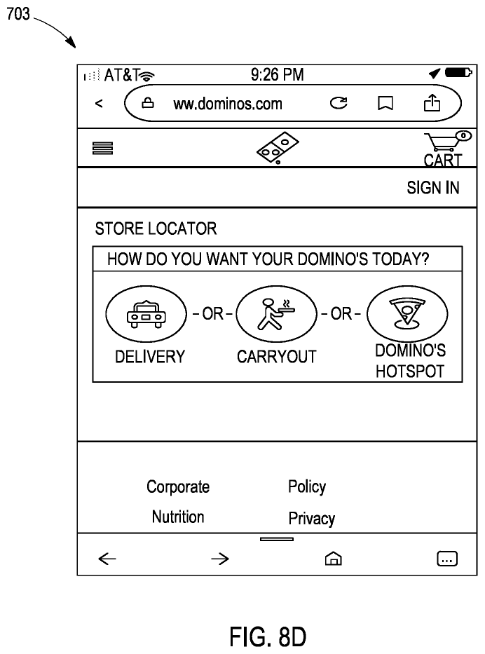

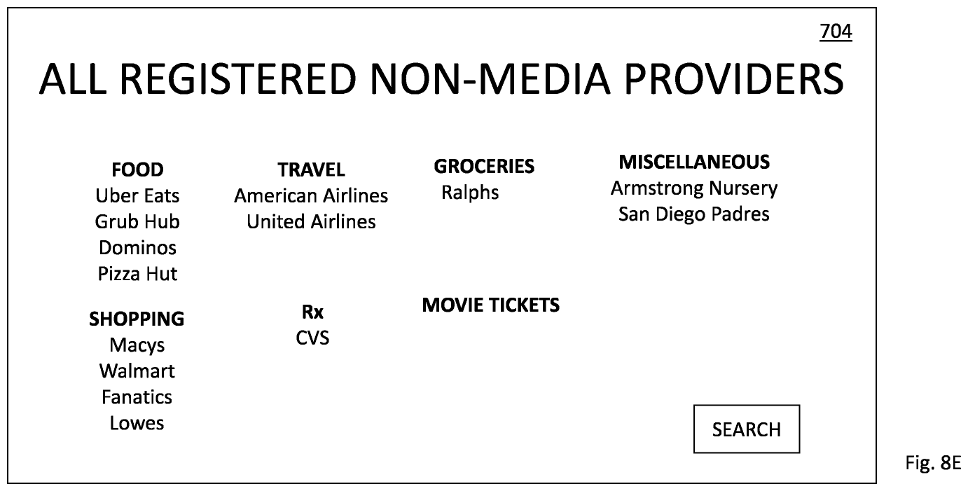

FIGS. 8A-8E illustrate screen shots of a food ordering options with the food preparation entities and food delivery entities associated with the interface according to the embodiments of the present invention. When a user selects the category of Food 610-1 from screen shot 601, the user advances to screen shot 700 shown in FIG. 8A. Screen shot 700 lists multiple food-related options including Uber Eats 615-1, Grub Hub 615-2, Postmates 615-3, DoorDash 615-4, Dominos 615-5, Pizza Hut 615-6, Subway 615-7 and Search 615-8. Those skilled in the art will recognize that the listed Food providers can include any number of providers desired. The list of Food providers may be pre-populated based on popularity or other factors or customized by the user. The list of Food providers may also be pre-populated with those Food providers with which the user has an account (i.e., is currently a registered user).

FIGS. 8B and 8C illustrate screen shots 701, 702 of pages that the user may advance to when selecting DoorDash 615-4 from screen shot 700. If the user does not have an account with DoorDash, the user advances to screen shot 701 where the user can create an account or continue as a guest. If the user does have an account with DoorDash, the user advances to screen shot 702 where the user can begin placing the order immediately. That is, like with the media content providers, the system stores the user's sign-in information so that the user need not take the time to enter such information each time the user accesses a category. Screen shot 703 shown in FIG. 8D is a Dominos sign-in page to which a user advances without being registered and having any account information stored by the system.

Screen shot 704 shown in FIG. 8E lists All Registered Non-Media Providers 615-7 of the user which may be selected from the list depicted on screen shot 601. As the user obtains more accounts, the list of All Registered Non-Media Providers 615-7 is updated. Screen shot 704 may act as the home page in place of screen shot 601.

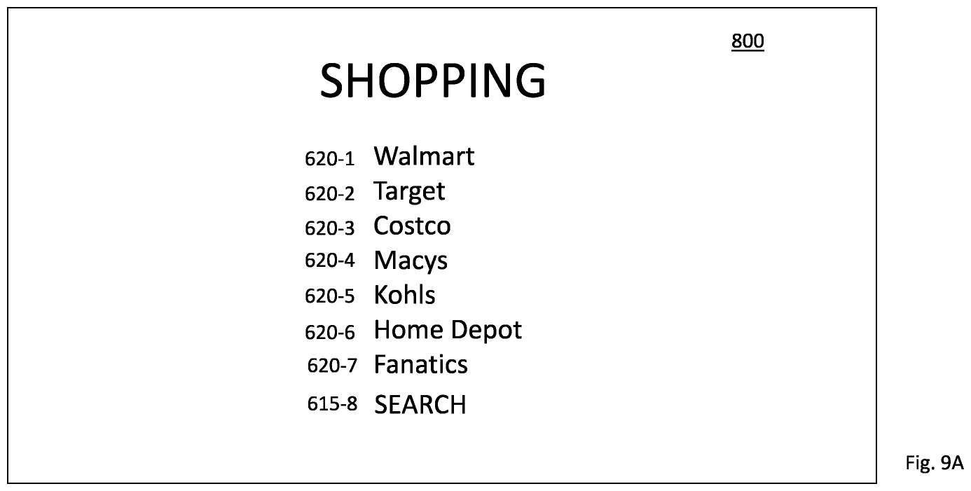

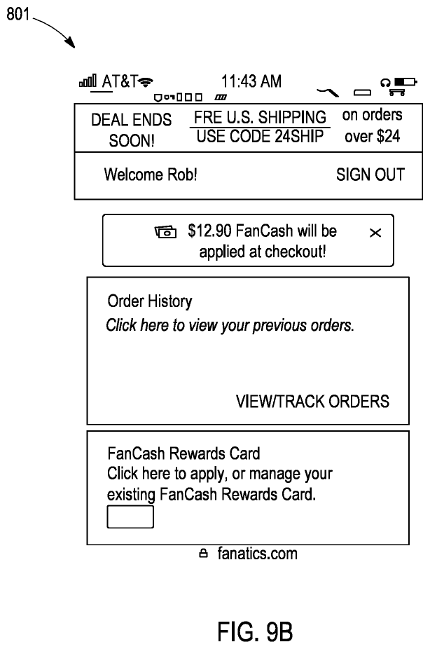

Screen shot 800 of FIG. 9A depicts a Shopping page which the user advances to after selecting the category of Shopping 610-3 from the list depicted on screen shot 601. Screen shot 801 of FIG. 8B shows a Fanatics page which the user advances based on selecting Fanatics 620-7 from the list on screen shot 800. As shown, the Fanatics page in screen shot 801 is based on a user already being registered therewith (i.e., no need for the user to independently sign in).

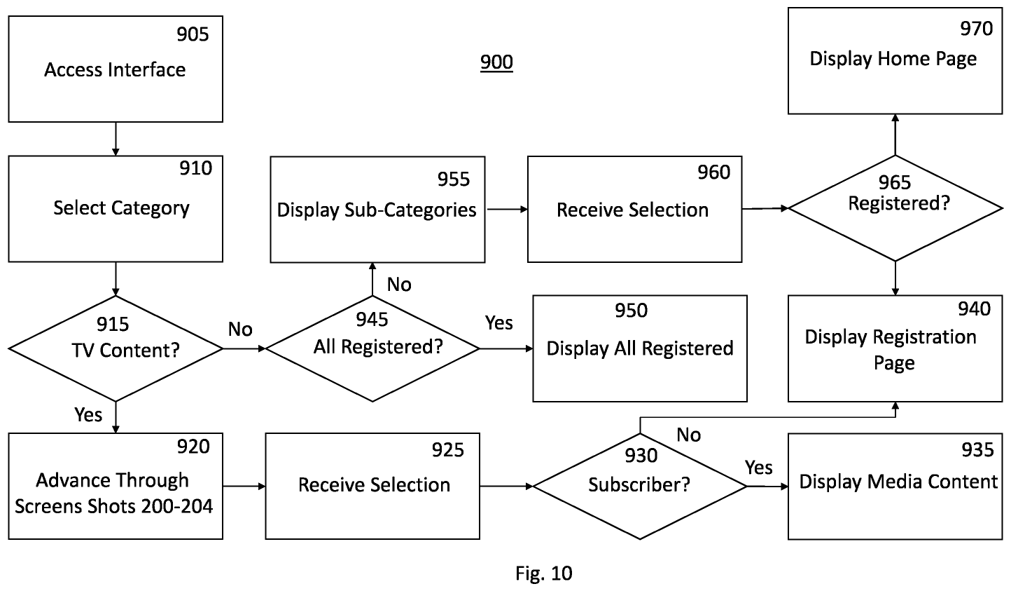

FIG. 10 shows a flowchart 900 detailing one exemplary method of advancing through the system via the interface. At 905, a user accesses the interface via their television. At 910, the user selects a category from the list depicted on screen shot 601. At 915 it is determined if the selection is a primary selection (i.e., media content 205-1 through 205-N). If the selection is a media content selection, at 920 the user advances through the sub-categories (i.e., screen shots 201-204 of FIGS. 4A-4E). At 925, the system receives an ultimate user selection from screenshot 204 of FIG. 4E. At 930, it is determined if the user has a subscription with the content provider of the selection. If so, at 935, the user advances directly to the movie or other content. If not, at 940, the user may advance to a subscription page for the content provider. If, at 910, the user selects non-media content, at 945, it is determined if the user selected All Registered Non-Media Providers 610-7. If so, at 950 All Registered Non-Media Providers is presented as shown in screen shot 704 of FIG. 8E. If, at 945, the user did not select All Registered Non-Media Providers 610-7, at 955 all Non-Media Provider Categories are displayed as shown in screen shot 601 of FIG. 7B. At 960, the system receives an ultimate user selection from the list of Non-Media Provider Categories 610-7. At 965, it is determined if the user is registered with the selected non-media provider. If so, at 970, the user advances directly to the home page of the non-media provider selected. If the user is not registered, at 940, the user may advance to a registration/guest page thereof.

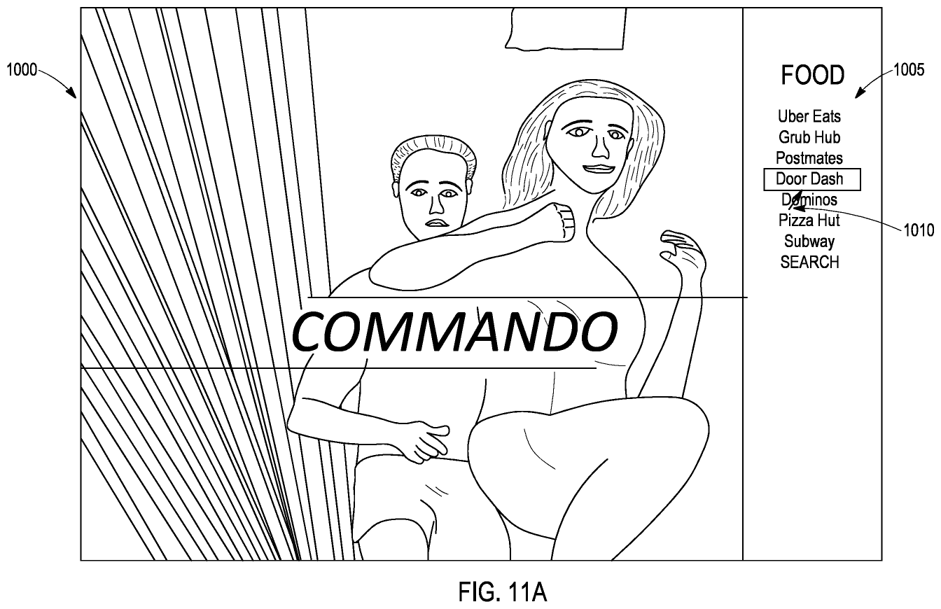

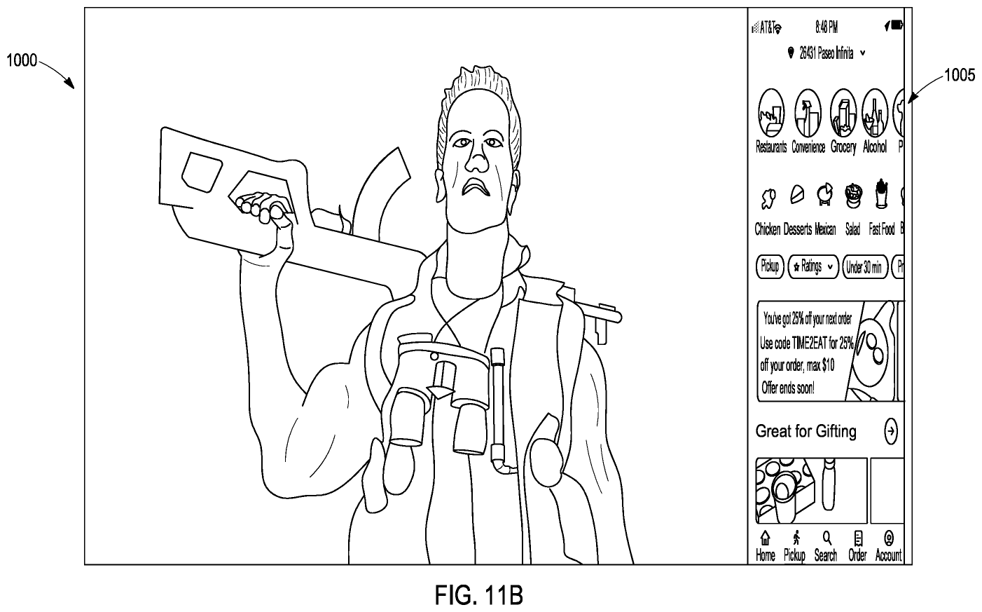

In one embodiment, the non-media content pages can be accessed during commercials or while the media content is paused. For example, if the user is streaming Commando, the user may pause the movie and access the non-media providers to order food, shop, etc. Alternatively, as shown in FIGS. 11A and 11B, the user may access the non-media content while the movie is actively streaming. In such an embodiment, the television screen is separated into a media content portion 1000 and non-media content portion 1005. As shown in FIG. 11A, the user is highlighting DoorDash with the cursor 1010. After selecting DoorDash, in FIG. 11B, the user, being a registered user, advances directly to the DoorDash home page where an order may be placed.

In one embodiment, the user may utilize the interface with a conventional television remote control (e.g., up and down buttons and/or wheel) or alternatively a unique remote control. With a unique remote control, the remote control may incorporate specific media content and non-media content buttons and inputs and the like to facilitate easy use of the digital interface. Alternatively, a software-based application downloadable on a mobile device allows users to easily search, view and use the mobile device interface (e.g., keyboard). Like the remote control, the mobile device interface may incorporate specific virtual buttons specific to the non-media content.

In another embodiment, users may make content recommendations for other users. In one embodiment, the system is configured to aggregate user's recommendations and make them available to users searching for similar information. For example, if a user enters “key moments in world war II,” the system may display relevant content after searching through each of the content providers' data and may also display any relevant stored recommendations from other users. Like other content, if a user is subscribed or a member to the content providers, the content begins playing when the user selects the same. Otherwise, subscription instructions are displayed.

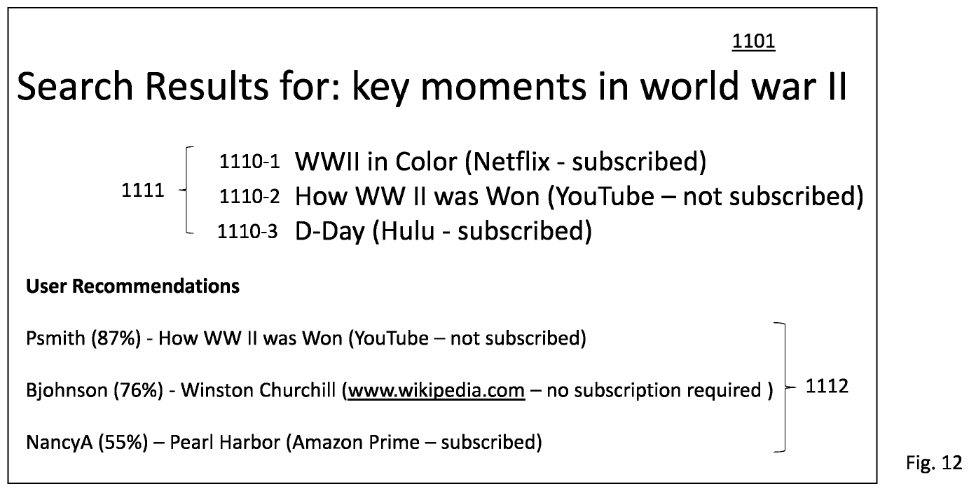

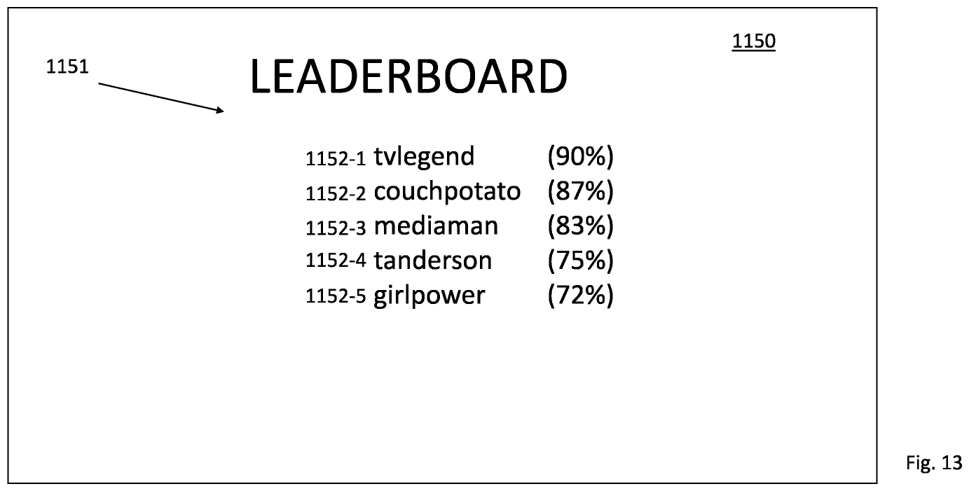

FIG. 12 shows a screen shot 1110 with a list of search results based on a search of each content provider's data 1111 and those recommended by users 1112. The search results include information on the content provider as well as whether the user is subscribed, not subscribed or subscription not required. In another embodiment, the system may display a table or leaderboard of the users making the best recommendations based on other user rating. Screen shot 1150 of FIG. 13 shows an exemplary leaderboard 1151 with the top 5 recommenders 1152-1 through 1152-5 ranked.

In one embodiment, users may rate other user's recommendations so that the users making recommendations may be rated for quality. In such an embodiment, the ratings are displayed adjacent to the user's name making the recommendation allowing users to gauge the quality of the user's recommendations.

In one embodiment, the system is configured to send users making recommendations statistics regarding their recommendations and how they are being received by other users. This information is ideally transmitted to the user through his or her own private app. Such information may include the number of times a recommendation is accessed via the recommendation, any positive or negative feedback regarding the recommendation, what percentile to which the user belongs, etc.

Although the invention has been described in detail with reference to several embodiments, additional variations and modifications exist within the scope and spirit of the invention.

I claim:

1. A system comprising:
a processor running executable instructions configured to access media content related to programming from multiple media content sources to which a user subscribes or may access via an electronic device;
an interface associated with said electronic device providing access to media content from the multiple media content sources; and
wherein upon selecting desired media content via the interface, the media content begins to play immediately without any source login requirements by the user or the interface prompts the user to subscribe to a media content source possessing the desired media content or purchase a viewing of the desired media content from a media content source for immediate viewing.

2. The system of claim 1 wherein the multiple media content sources are selected from cable, over-the-top, streaming, on-demand and satellite sources, websites, podcasts and social media sites.

3. The system of claim 1 wherein the interface communicates with application programming interfaces associated with the multiple media content sources.

4. The system of claim 1 further comprising memory to store login information associated with a user's media content source subscriptions and memberships.

5. The system of claim 1 further comprising said processor running executable instructions configured to: receive user recommendations responsive to search requests and rate quality of said recommendations.

6. A method of accessing media content comprising:
utilizing a processor running executable instructions to access media content related to programming from multiple media content sources to which a user subscribes or may access via an electronic device;
providing an interface associated with said electronic device configured to access media content from the multiple media content sources; and
responsive to a user selecting desired media content via the interface, immediately playing the media content without any source login requirements by the user or prompting, via the interface, the user to subscribe to a media content source possessing the desired media content or to purchase a viewing of the desired media content from a media content source for immediate viewing.

7. The method of claim 6 further comprising selecting the multiple media content sources from cable, over-the-top, streaming, on-demand and satellite sources, websites, podcasts and social media sites.

8. The method of claim 6 further comprising configuring the interface to communicate with application programming interfaces associated with the multiple media content sources.

9. The method of claim 6 further comprising storing login information associated with a user's media content source subscriptions.

10. The method of claim 6 further comprising utilizing said processor running executable instructions to receive user content recommendations responsive to search requests and rate quality of said recommendations.

11. A system comprising:
a processor running executable instructions configured to access media content related to programming from multiple media content sources to which a user subscribes or may access via an electronic device and non-media content;
an interface associated with said electronic device providing access to media content from the multiple media content sources, the interface further configured to provide access to non-media content; and
wherein upon selecting desired media content via the interface, the media content begins to play immediately without any source login requirements by the user or the interface prompts the user to subscribe to a media content source possessing the desired media content or to purchase a viewing of the desired media content from a media content source for immediate viewing, and wherein upon selecting desired non-media content from the interface, a user is advanced to a home page or login page associated with the non-media content.

12. The system of claim 10 wherein the interface is configured to present media content and non-media content simultaneously on a same display.

13. The system of claim 10 wherein the multiple media content sources are selected from cable, over-the-top, streaming, on-demand and satellite sources, websites, podcasts and social media sites.

14. The system of claim 10 wherein the interface communicates with application programming interfaces associated with the multiple media content sources.

15. The system of claim 10 further comprising memory to store login information associated with a user's media content source subscriptions and/or non-media content sources.

16. The system of claim 10 further comprising an Internet connection for accessing the media content and non-media content.

17. The system of claim 1 further comprising said processor running executable instructions configured to: receive user recommendations responsive to search requests and rate quality of said recommendations.
